(19) United States
(12) Patent Application Publication
(10) Pub. No.: US 2026/0172295 A1
(43) Pub. Date: Jun. 18, 2026

(54) LANE ALIGNMENT FOR SYMBOL MULTIPLEXED WIRED COMMUNICATION SYSTEMS

(71) Applicant: XILINX, INC., San Jose, CA (US)

(72) Inventor: Martin RIIS, Edinburgh (GB)

(21) Appl. No.: 18/984,891

(22) Filed: Dec. 17, 2024

(51) Int. Cl. H04L 25/14

(52) U.S. Cl. CPC H04L 25/14

(57) ABSTRACT

Alignment detection circuitry is disclosed that include a buffer configured to output a data stream of multiplexed groups of symbols from multiple data lanes and a set of correlators configured to determine physical link skew from one data lane of the multiple data lanes, wherein the physical link skew from the one data lane is known to equal the physical link skew on each data lane, assuming each data lane is transmitted over the same physical link. The alignment detection circuitry may also include anti-aliasing circuitry configured to extract a unique marker of the alignment marker to detect common marker aliasing by comparing the extracted unique marker to a known unique marker. Anti-aliasing circuitry may also be configured to use common marker detection status of adjacent data lanes of the multiple data lanes to detect common marker aliasing determined by a detection delay between the adjacent data lanes.

### TECHNICAL FIELD

Examples of the present disclosure generally relate to communication systems, and, in particular, to detecting alignment markers in wired communication systems.

### BACKGROUND

In high-speed wired communications systems, data, often from multiple parallel lanes, is multiplexed onto and transmitted over a physical link (e.g., electrical or optical). When multiple lanes are used, achieving and maintaining accurate lane alignment at the receiver is important to ensure data integrity and synchronization. When multiple parallel lanes are symbol multiplexed onto a single physical link, additional alignment challenges are presented, including skew and alignment marker aliasing.

### SUMMARY

One embodiment described herein is alignment detection circuitry including a buffer configured to output a data stream of multiplexed groups of symbols from multiple data lanes and a set of correlators configured to determine physical link skew from one data lane of the multiple data lanes, wherein the physical link skew from the one data lane is known to equal the physical link skew on each of the data lanes, assuming they are each transmitted over the same physical link.

One embodiment described herein is alignment detection circuitry including a buffer configured to output a data stream of multiplexed groups of symbols from multiple data lanes, a set of correlators configured to detect a common marker of an alignment marker, and anti-aliasing circuitry configured to extract a unique marker of the alignment marker to detect common marker aliasing by comparing the extracted unique marker to a known unique marker.

One embodiment described herein is alignment detection circuitry including a buffer configured to output a data stream of multiplexed groups of symbols from multiple data lanes and anti-aliasing circuitry configured to use common marker detection status of adjacent data lanes of the multiple data lanes to detect common marker aliasing.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIGS. 1A-1B illustrate a diagram for a multiplexing and a demultiplexing operation for a plurality of data lanes, according to an example.

FIG. 2 illustrates using correlator circuits to detect the alignment markers, according to an example.

FIGS. 3A-3D illustrate common marker aliasing in symbol-pair multiplexing, according to an example.

FIGS. 4A-4D illustrate avoiding common marker aliasing in symbol-pair multiplexing by inserting unique markers followed by the common markers, according to an example.

FIG. 5 illustrates the appearance of a common marker and a unique marker extracted from a data stream for an even lane, according to an example.

FIG. 6 illustrates the appearance of a common marker and a unique marker extracted from a data stream for an odd lane, according to an example.

FIGS. 7A-7D illustrate the unique marker that may be extracted after the aliased common marker is detected to detect common marker aliasing in symbol-pair multiplexing, according to an example.

FIGS. 8A-8D illustrate timing diagrams for detecting the aliased common marker, according to an example.

FIGS. 9A-9D illustrate circuits used to detect the aliased common marker, according to an example.

FIGS. 10A-10B illustrate circuits used to detect an even lane and an odd lane to avoid common marker aliasing, according to an example.

FIG. 11 illustrates a flowchart for alignment marker detection by determining skew from one lane of the multiple data lanes to determine skew across all data lanes, according to an example.

FIG. 12 illustrates a flowchart for alignment marker detection by using anti-aliasing circuitry to extract a unique marker to detect common marker aliasing, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

In wired communication systems, ensuring the accurate alignment of data packets is important for maintaining synchronization and data integrity. Alignment markers, also known as synchronization markers, are embedded within the transmitted data on each lane to serve as reference points for synchronization at the receiver end. These markers help the receiver to identify the start and end of data frames, correct timing offsets, and align multiple data streams. Detecting these markers poses unique challenges due to several factors.

The IEEE 802.3 Ethernet standard is a collection of networking standards that define the physical layer and data link layer's media access control (MAC) for wired Ethernet networks. This standard specifies the requirements for different Ethernet speeds, including 10 Mb/s, 100 Mb/s, 1 Gb/s, 10 Gb/s, 40 Gb/s, 100 Gb/s, 200 Gb/s, 400 Gb/s, and up to 1.6 Tb/s. The standard ensures interoperability and reliable communication between devices in local area networks (LANs), metropolitan area networks (MANs), and wide area networks (WANs).

The IEEE 802.3 Ethernet standard defines a method for transmitting data at high speeds over an electrical or optical interface (physical link) at different data rates, using one or more data lanes or lanes. To ensure the receiver and transmitter are synchronized in higher data rates, alignment markers are inserted. These are known patterns of bits inserted by the transmitter at regular intervals, and detected by the receiver. The alignment markers consist of two parts, a common marker, followed by a unique marker, both 48 bits in length. The common marker is common across all lanes and is used to align the incoming deserialized data to symbol and codeword boundaries. The unique marker is unique on each lane and is used to reorder lanes that may have been disordered between the transmitter and receiver (e.g., wires getting crossed). Ethernet standards that use alignment markers mostly make use of 25 Gbps lanes. These lanes can either be mapped directly to individual physical links (wire/optical fiber), or multiple lanes can be multiplexed together onto a single physical link capable of data rates of 50 Gbps or higher.

The IEEE 802.3dj standard provides support for multiplexing eight 25 Gbps data lanes onto a single 200 Gbps physical link and for multiplexing two 100 Gbps data lanes onto a single 200 Gbps physical link. The IEEE 802.3dj standard also introduces two methods of multiplexing the data lanes onto the physical link which are symbol-pair multiplexing and symbol-quartet multiplexing. It is to be appreciated that systems and techniques described herein in relation to symbol-pair multiplexing are equally applicable to symbol-quartet multiplexing and other symbol multiplexing methods (for example, symbol-octet), except where differences between implementations are described.

Symbol multiplexing is a technique employed in wired communication systems where high-speed physical links, such as 200 Gbps, are used. This method uses a round robin approach to multiplex groups of one or more symbols from multiple lanes onto a single physical link. In relation to IEEE 802.3dj symbol-pair multiplexing, groups of two symbols from each of the eight data lanes multiplexed onto the single 200 Gbps physical link one lane at a time in a round-robin fashion. Likewise, in relation to IEEE 802.3dj symbol-quartet multiplexing, groups of four symbols from each of the two lanes are multiplexed onto the single 200 Gbps physical link one at a time in a round-robin fashion. In IEEE 802.3, the length of a symbol is 10 bits. It can be appreciated that any number of data may be multiplexed in groups of any size onto a physical link of any rate.

Lane alignment in symbol multiplexed wired communication systems refers to the process of ensuring that data transmitted across multiple parallel lanes arrive at the receiving end with the correct order and timing alignment. Misalignment can lead to errors and incorrect data interpretation. The primary cause of misalignment is skew. Skew between lanes occurs when there is a timing difference between signals traveling across different lanes. In other words, data from one lane arrives sooner in time than data from another lane. Variations in the length of the transmission paths, differences in electrical properties, or signal propagation delays can cause lane skew.

Alignment markers are used to help the receiver detect and correct for any misalignment or skew that may occur during data transmission over multiple parallel lanes. Alignment markers ensure that the data from each lane is correctly aligned and synchronized. Alignment markers are usually predefined bit patterns that are distinct and easily recognizable. Alignment markers are inserted at regular intervals within the data stream. The receiver looks for these specific patterns to determine the correct boundaries of the data frames or packets and to adjust the timing of the received signals from different lanes.

In an IEEE 802.3dj transmitter using symbol-pair multiplexing, data from the eight lanes is multiplexed in groups of two symbols onto the physical link in a round-robin fashion. Additionally, for symbol-pair multiplexing, odd numbered lanes are delayed by one symbol (10 bits) with respect to even lanes. This is specific to the IEEE 802.3dj symbol-pair multiplexing specification and does not represent a requirement for methods of symbol multiplexing. Symbol-quartet multiplexing follows the same principle, except four symbols are output per lane, rather than two, and no odd lane delay is applied. The multiplexed data will be serialized and outputted on the physical medium (e.g., electrical or optical) using specialized serializer hardware.

At the receiver, de-multiplexing is performed to reverse the multiplexing operation performed in the transmitter. In most cases, bit 0 of a symbol-pair will not be aligned to bit 0 of the deserialized output. This is due to the time at which the deserializer starts sampling data. This misalignment is referred to as physical link skew.

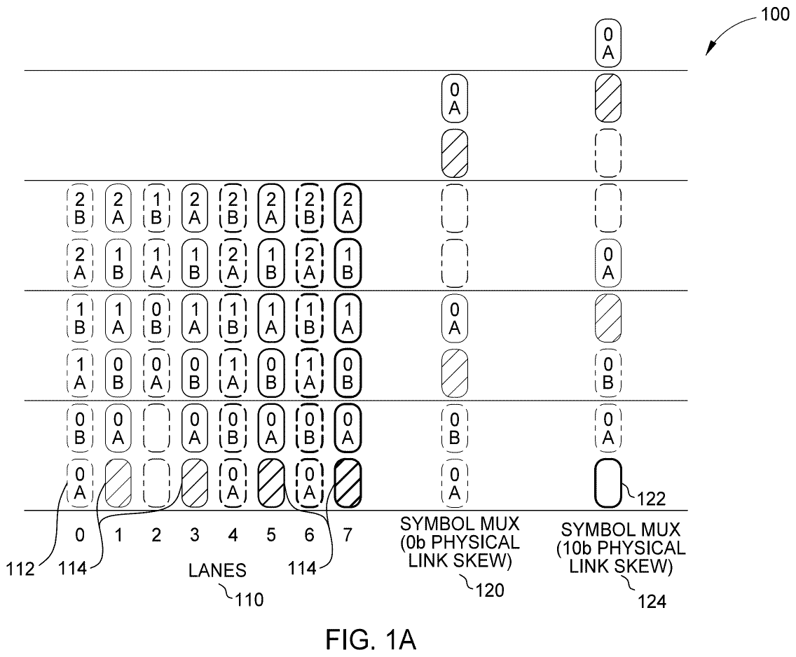

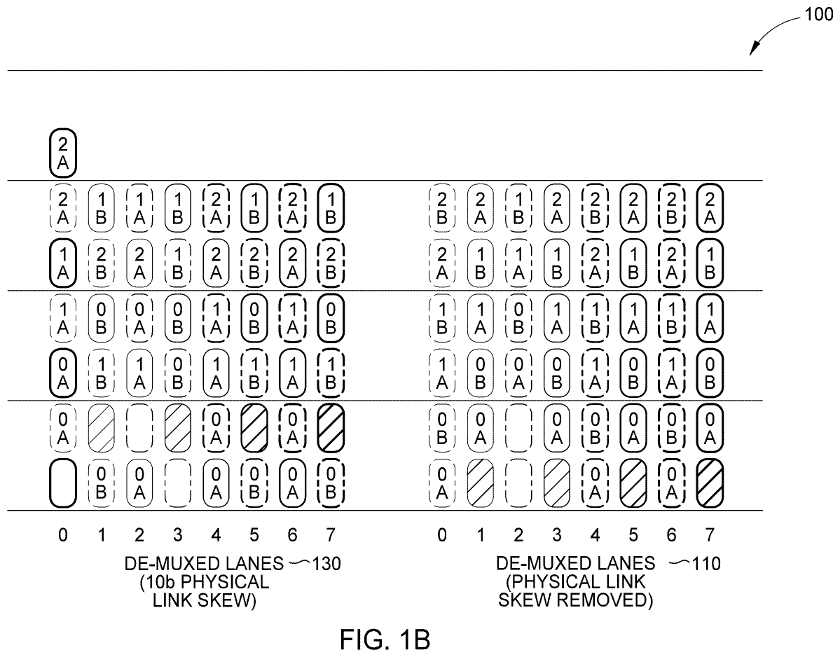

In FIG. 1A below, the physical link skew is 10 bits, or one symbol. This results from the deserializer starting sampling 10 bits before the start of a symbol-pair. Thus, each de-multiplexed lane contains symbols from two different lanes, as illustrated in FIG. 1B. This illustrates the need for detection and correction of physical link skew when recovering received data.

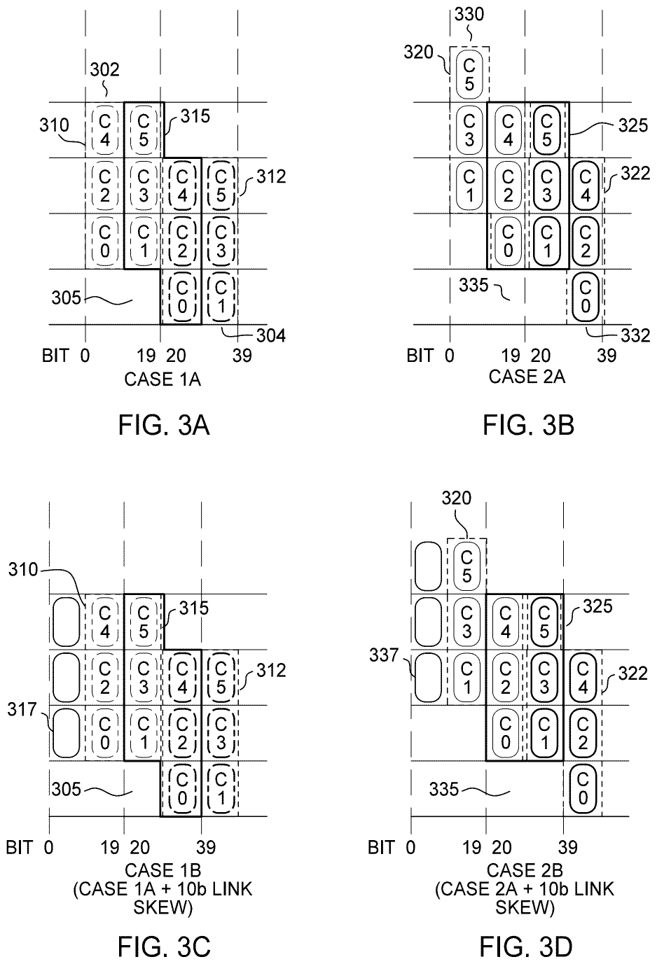

Another issue in wired communication systems relates to misidentification of lane alignment markers using symbol-pair multiplexing, as shown in FIGS. 3A-3D below. Misidentification of lane alignment markers can result from what is referred to herein as common marker aliasing. Common marker aliasing is a phenomenon seen in IEEE 802.3dj symbol-pair multiplexing caused by two common markers from adjacent lanes being positioned in a certain way with respect to one another. This can lead to an additional aliased common marker appearing which may lead to challenges in alignment if the aliased marker is not correctly ignored.

The example embodiments propose solutions to address issues in detecting alignment markers in wired communication systems using symbol multiplexing and to address issues in misidentification of lane alignment markers in wired communication systems using symbol-pair multiplexing due to common marker aliasing. For the first issue, it is sufficient to only check for alignment markers on one lane to determine the physical link skew using multiple correlator circuits. This is possible as multiple lanes are multiplexed onto a single physical link, therefore the skew introduced from the physical link will be equally reflected on all lanes transmitted over the physical link. Once the physical link skew is found and corrected, the skew between lanes can be found using multiple correlator circuits and corrected. For the second issue, area-optimal architectures are employed to prevent misidentification of lane alignment markers due to common marker aliasing. In a first architecture, the unique marker is used for the anti-aliasing logic. In a second architecture, the common marker detection status of adjacent lanes is used to detect cases of aliasing. In other words, unique alignment markers may be used to validate the correctness of the detection or common alignment marker detections from adjacent lanes to detect and cancel out common marker aliasing.

FIGS. 1A-1B illustrate a diagram for a multiplexing and a demultiplexing operation for a plurality of data lanes, according to an example.

FIGS. 1A-1B relate to symbol-pair multiplexing. However, the example embodiments below can also be applied to symbol-quartet multiplexing and any other method of symbol multiplexing.

Referring to FIGS. 1A-1B, the diagram 100 depicts the 200 Gbps physical link including 8 data lanes (e.g., data lanes 110), where each data lane is 25 Gbps. The data lanes 110 may be designated as 0, 1, 2, 3, 4, 5, 6, and 7. In other words, each 200 Gbps physical link is formed from 8 separate data lanes, with each data lane capable of transmitting data at 25 Gbps. Thus, the total aggregate bandwidth reaches 200 Gbps (8 lanes×25 Gbps per lane).

Each rectangle 112 represents a symbol. Each symbol has a length of 10 bits. Each lane shows 6 symbols or 3 symbol-pairs. For example, (0, A) and (0, B) are a symbol pair. Each odd lane includes a delay 114. The data lanes 110 are multiplexed as shown by symbol multiplexed lane 120 representing the lane data after being symbol multiplexed onto the physical link.

In various embodiments, a physical link skew 122 is introduced by the deserializer starting to sample 10 bits before the start of symbol (0, A) and shown in the symbol multiplexed physical link with skew 124.

At the receiver end, demultiplexing of the symbol multiplexed physical link with skew 124 takes place. The demultiplexed lanes 130 are shown in FIG. 1B. The demultiplexed lanes 130 include physical link skew 122 and do not match the data lanes 110 on the transmitter end. To remedy this, the example embodiments provide a mechanism to identify and remove the physical link skew 122 from the demultiplexed lanes 130 to properly reconstruct the data lanes 110. To properly reconstruct the data lanes 110 on the receiver end, the following methodology is presented.

Since the 200 Gbps link skew is guaranteed to be equal across all data lanes, it is sufficient to only check for alignment markers on one base lane to find the value of the 200 Gbps link skew.

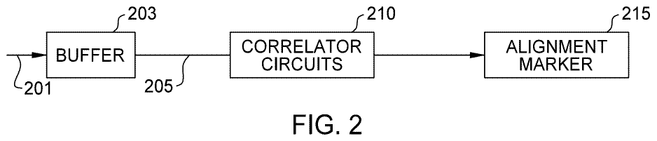

In one embodiment, checking for alignment markers on the base lane is performed by a bank of 20 correlator circuits, each assuming a different symbol pair alignment (physical link skew) between 0 and 19 bits. 20 correlator circuits are used as the size of a symbol-pair is 20 bits. In symbol-quartet multiplexing, 40 correlators would be required, each assuming a different symbol-quartet alignment between 0 and 39 bits, FIG. 2 illustrates using correlator circuits that search the base data lane of the physical link data stream in parallel for bits that match bits of a reference alignment marker. Notably, in the IEEE 802.3dj symbol-pair multiplexing standard, odd numbered data lanes include a 10 bit offset and even numbered data lanes do not include the 10 bit offset. Since the candidate data lane may be even numbered or odd numbered, two banks of 20 correlator circuits are required. The first bank of correlator circuit searches the candidate data lane without the 10 bit offset (assuming an even numbered lane) and the second bank of correlator circuit searches the candidate data lane with the 10 bit offset (assuming an odd numbered lane).

The correlator circuitry is illustrated to include a buffer 203 and correlator circuits 210 for checking for alignment markers 215. In one or more embodiments, the buffer 203 receives an input 201, which may be received directly from a physical interface (e.g., the single 200 Gbps physical link). For example, the input 201 can be received from a serializer/deserializer (SERDES) circuit. In some embodiments, the buffer 203 receives the input 201 after an output from the physical interface has been processed at least partially.

The buffer 203 processes the input 201 to generate an output 205. In some examples, the output 205 is a data stream of multiplexed symbols (multiplexed groups of symbols) from multiple data lanes (e.g., the eight 25 Gbps data lanes). The groups of symbols can be symbol-pairs, symbol-quartets, symbol-octets, etc. In various embodiments, the buffer 203 generates the output 205 for processing by the correlator circuits 210, including for example 20 correlators. The correlator circuits 210 can be implemented using hardware (e.g., digital logic circuit), software, or a combination of hardware and software. For example, the buffer 203 may buffer the input 201 into candidate data lanes in order to generate the output 205.

In an example in which the length of a symbol is 10 bits and the groups of symbols are symbol-pairs, then each group corresponds to a candidate data lane and there are 20 possible scenarios for physical link skew. In this example, the skew can be between 0 and 19 bits (e.g., 20 bits of skew is equivalent to 0 bits). Continuing this example, the correlator circuits 210 can include 20 different correlators to check for each of the 20 possible scenarios for the skew. For example, the correlator circuits 210 evaluate 20 different starting points for de-multiplexing the output 205.

In another example in which the groups of symbols are symbol-quartets, then there are 40 possible scenarios for physical link skew (e.g., the skew can be between 0 and 39 bits). Notably, in this other example, two 100 Gbps data lanes are multiplexed together and the odd numbered data lane is not delayed relative to the even numbered data lane. In this example, the correlator circuits 210 may include 40 different correlators to check for the 40 possible scenarios for the skew.

In some embodiments, the output 205 is a data stream of multiplexed groups of symbols from multiple data lanes, and some of these data lanes are offset (e.g., by an amount corresponding to one symbol). For instance, the IEEE 802.3dj symbol-pair multiplexing standard includes an offset of 10 bits for odd numbered data lanes and no offset for even numbered data lanes. In various embodiments, data lanes of the output 205 which do not include an offset are de-multiplexed using a first de-multiplexing method (e.g., which does not account for the offset) and data lanes of the output 205 which include the offset are de-multiplexed using a second de-multiplexing method (e.g., which accounts for the offset).

In some embodiments, the correlator circuits 210 search the candidate data lane of the output 205 for bits matching an entirety of the reference alignment marker (e.g., search for 48 bits that match a 48 bit reference alignment marker). In other embodiments, the correlator circuits 210 search the candidate data lane of the output 205 for bits matching a subset of the bits of the reference alignment marker (e.g., search for 9 nibbles that match a first 9 nibbles of a 12 nibble reference alignment marker). Although examples are described relative to a 48 bit (12 nibble) reference alignment marker, it is to be appreciated that the described systems and techniques apply equally to examples of larger/smaller reference alignment markers and larger/smaller subsets of the reference alignment markers.

Therefore, for the sequential detection method, the 20 correlators may be initially configured to search for alignment markers with the assumption the base lane is even numbered. This search is performed for a window of time equal to the spacing between alignment markers. This spacing is defined in the IEEE 802.3 standard. Following this window, the 20 correlators may be configured to search for alignment markers with the assumption the base lane is odd numbered. This search is performed for the same window of time.

If a common marker is detected during the first window, it can be assumed that the base lane is even numbered. Likewise, if the common marker is detected during the second window, it can be assumed the base lane is odd numbered. The index of the correlator that made the detection can then be used to determine the skew on the 200 Gbps physical link. For example, if the correlator with deserialized data having a bit offset of 7 bits made the detection during the even window, it can be assumed the physical link skew was 7 bits.

Due to the specifics of symbol-pair multiplexing, alignment marker anti-aliasing may be included to ensure an aliased alignment marker is not detected. Such logic is described below with reference to FIGS. 3-10.

Referring to FIGS. 1A-2, in one embodiment, one lane is used to initially detect the skew on the physical link. This information can then be used to remove the skew on the physical link using, for example, bit shift logic. This allows the alignment markers on all lanes transmitted over the physical link to be detected more efficiently.

As shown in FIGS. 1A-1B, once the physical link skew is removed, the alignment markers on each lane will either start at bit 0 (even lane) or bit 10 (odd lane). The start of an alignment marker is shown as symbol (0, A). To detect these, per-lane correlators can be used. If the physical link is 200 Gbps with a 160 bit width and 8 lanes are symbol-pair multiplexed onto it, each lane will have a 20 bit width, equal to the width of a symbol-pair. With 20 bit per-lane deserialized data, each lane uses two correlators, one even and one odd. The time at which these alignment markers are detected by the correlator circuitry can be used to remove the lane skew on the individual lanes. As this occurs after the detection of the physical link skew, the correlator circuitry used for physical link skew detection can be reused, further reducing the number of resources utilized. The use of an initial physical link skew detection to deskew the physical link prior to the detection of alignment markers for all lanes is different compared to traditional techniques.

The above methodology pertained to symbol-pair multiplexing. However, such methodology can also apply to symbol-quartet multiplexing. Symbol-quartet multiplexing is currently used in 1.6 Tbps Ethernet where 100 Gbps lanes are used, meaning only two lanes are multiplexed onto a single 200 Gbps physical link. The odd lane delay is not present, simplifying the detection method. Regardless, the same method by which a base lane is monitored for common markers to obtain the 200 Gbps physical link skew, before skew correction and full alignment marker detection can be still used. The method described above can also be transferred to any future symbol-based multiplexing method, regardless of the number of data lanes, or the presence of delays on some data lanes with respect to others.

Additionally, with reference to FIG. 2, since the physical link skew on only one data lane needs to be determined, less correlators may be used. One thing that is common across all 8 lanes is the physical link skew. As such, only one set of correlators can be used on one lane to detect the physical link skew. In other words, the other seven lanes do not need correlators or a set of 20 correlators each, which significantly reduces the number of correlators used to determine the physical link skew or misalignment. The correlator circuitry thus only checks one base lane to determine the alignment marker on that one base lane. Once the physical link skew is determined for that one base lane, such skew is the same for all other data lanes.

In an alternative embodiment, the method for the detection of the physical link skew can be achieved in just one alignment marker window period if double the number of correlators were used. In such a design, using symbol-pair multiplexing, 20 correlators assume an even lane and another 20 assume an odd lane. This achieves the same results as the example embodiments, however, it involves double the number of correlator resources. Such a design can still make use of the method by which the skew detected on a base lane is used for the removal of skew on the physical link. It is noted that there is no requirement in the IEEE 802.3 specification for the receive logic to obtain alignment lock in a specific period of time or after a certain number of alignment markers. Compared to the conventional solutions, the example embodiments offer an approximately 75% reduction in resource utilization due to the highly optimized alignment marker detection method and the re-use of correlators for multiple, different correlation operations. Additionally, the example embodiments can detect alignment markers and de-multiplex received data that has been symbol multiplexed in accordance with the IEEE 802.3dj standard.

FIGS. 3A-3D illustrate common marker aliasing in symbol-pair multiplexing, according to an example.

Common marker aliasing refers to a phenomenon in IEEE 802.3dj symbol-pair multiplexing where two instances of a common marker from adjacent lanes can be offset in such a way, resulting in the appearance of a third aliased common marker. This can cause alignment issues or failure if the alignment logic cannot identify and ignore the aliased common marker.

In FIG. 3A, in Case 1A, each rectangle represents a symbol, where C0 through C5 are the symbols within a common marker. A first group of symbols 310 with a first common marker (of a first lane) is shown adjacent a second group of symbols 312 (of a second lane) with a second common marker. A common marker aliasing outline is depicted between the first group of symbols 310 and the second group of symbols 312. In other words, the first even lane common marker and the second even lane common marker of adjacent lanes creates an aliased odd lane common marker 315 shown by the central bold aliasing outline. The shift or delay 305 is shown between the lower lane 302 (left side) and the upper lane 304 (right side). The delay 305 may be one clock cycle. In this example, the first group of symbols 310 and the second group of symbols 312 are even lane common markers. The aliased common marker 315 appears to be an odd lane marker because of the 10-bit delay.

In FIG. 3A, Case 1A shows the aliasing with 0 bits of 200 Gbps link skew, where the same behavior is seen for up-to 9 bits of link skew. FIG. 3C shows the aliasing with 10 bits of link skew, the same behavior is seen for up-to 19 bits of link skew. Due to a symbol pair being 20 bits, a link skew of 20 bits appears as a link skew of 0 bits with an extra cycle of delay.

In Cases 1A and 1B, two even numbered lanes are spatially adjacent, with the lower lane 302 temporally shifted by 20 bits with respect to the upper lane 304, that is, the lower lane 302 arrives at the receiver one clock cycle later than the other lane. The aliased common marker 315 shows how the common markers from both lanes can be seen to merge into what appears to be a common marker from an odd numbered lane.

Thus, in FIGS. 3A and 3C, the receiver, instead of identifying two even lanes, the receiver may identify one single odd lane, or two even lanes and one odd lane.

In FIG. 3B, in Case 2A, each rectangle represents a symbol, where C0 through C5 are the symbols within a common marker. A first group of symbols 320 with a first common marker (of a first lane) is shown adjacent a second group of symbols 322 (of a second lane) with a second common marker. A common marker aliasing outline is depicted between the first group of symbols 320 and the second group of symbols 322. In other words, the first odd lane common marker and the second odd lane common marker of adjacent lanes creates an aliased even lane common marker 325 shown by the central bold aliasing outline. The shift or delay 335 is shown between the lower lane 330 (left side) and the upper lane 332 (right side). The delay 335 may be one clock cycle. In this example, the first group of symbols 320 and the second group of symbols 322 are odd lane common markers. The aliased common marker 325 appears to be an even lane marker because of the 10-bit delay.

In FIG. 3B, Case 2A shows the aliasing with 0 bits of 200 Gbps link skew, where the same behavior is seen for up-to 9 bits of link skew. FIG. 3D shows the aliasing with 10 bits of link skew, the same behavior is seen for up-to 19 bits of link skew. Due to a symbol pair being 20 bits, a link skew of 20 bits appear as a link skew of 0 bits with an extra cycle of delay.

In Cases 2A and 2B, two odd numbered lanes are spatially adjacent, with the lower lane 330 temporally shifted by 20 bits with respect to the upper lane 332, that is, the lower lane 330 arrives at the receiver one clock cycle later than the other lane. The aliased common marker 325 shows how the common markers from both lanes can be seen to merge into what appears to be a common marker from an even numbered lane.

Thus, in FIGS. 3B and 3D, the receiver, instead of identifying two odd lanes, the receiver may identify one single even lane, or two odd lanes and one even lane.

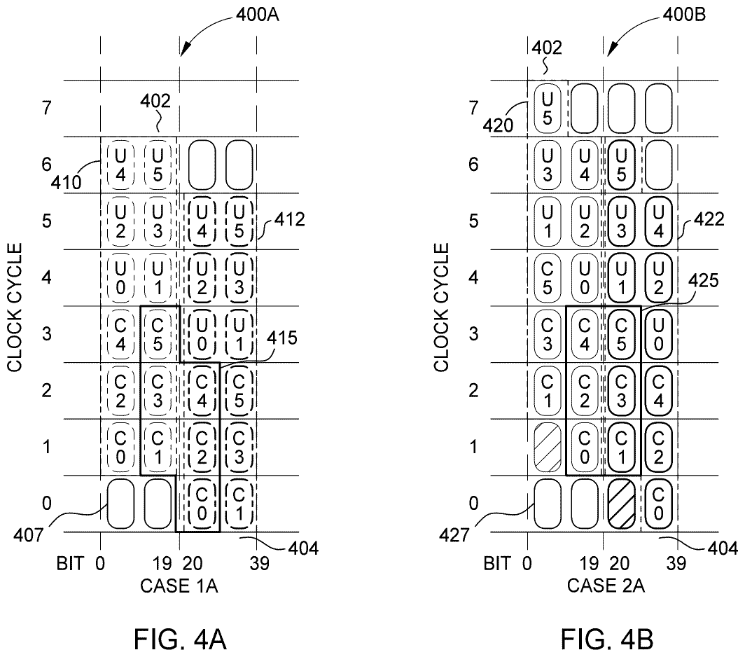

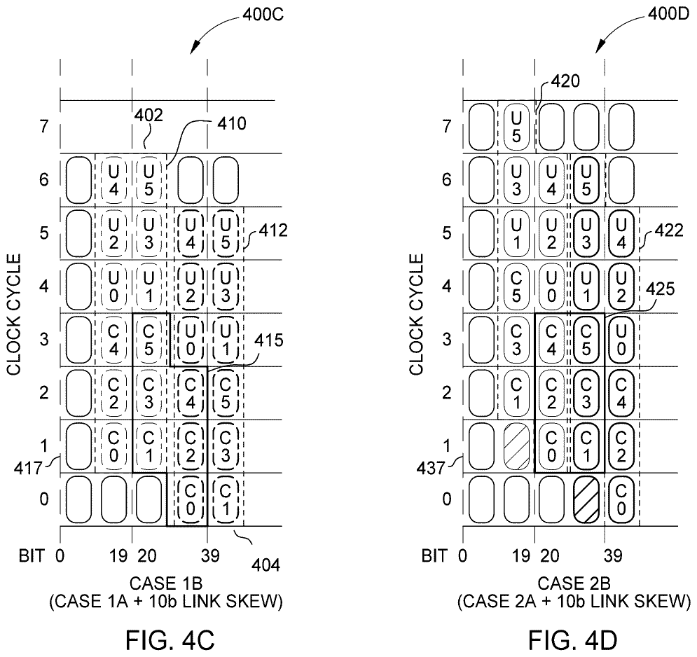

The common marker aliasing in FIGS. 3A-3D can cause challenges when detecting alignment markers, as basic logic may misinterpret an even lane for an aliased odd lane, or vice versa, causing incorrect de-multiplexing. Therefore, aliasing needs to be taken into consideration in the alignment marker detection logic. FIGS. 4A-10B below provide a solution to overcoming the common marker aliasing issue.

FIGS. 4A-4D illustrate avoiding common marker aliasing in symbol-pair multiplexing by checking the unique markers that follow the common markers, according to an example. It should be appreciated that FIGS. 4A, 4B, 4C, and 4D have identical physical link skew and lane skew characteristics to FIGS. 3A, 3B, 3C, and 3D respectively.

In FIGS. 4A and 4C, each rectangle represents a symbol, where C0 through C5 are the symbols within a common marker and U0 through U5 are the symbols for a unique marker. The unique marker follows the common marker and provides additional or specific information relevant to the identification of the lane.

In 400A, a first group of symbols 410 (of a first lane) with a first common marker and a first unique marker is shown adjacent a second group of symbols 412 (of a second lane) with a second common marker and a second unique marker. An aliased common marker 415 is shown by the central bold aliasing outline. The shift or delay 407 is shown below the lower lane 402 (left side). The delay 407 may be one clock cycle.

In 400C, an equivalent example to 400A is shown, except with a physical link skew of 10 bits.

In FIGS. 4B and 4D, each rectangle represents a symbol, where C0 through C5 are the symbols within a common marker and U0 through U5 are the symbols for a unique marker. The unique marker follows the common marker and provides additional or specific information relevant to the data stream.

In 400B, a first group of symbols 420 (of a first lane) with a first common marker and a first unique marker is shown adjacent a second group of symbols 422 (of a second lane) with a second common marker and a second unique marker. An aliased common marker 425 is shown by the central bold aliasing outline. The shift or delay 427 is shown below the lower lane 402 (left side). The delay 427 may be one clock cycle.

In 400D, an equivalent example to 400B is shown, except with a physical link skew of 10 bits.

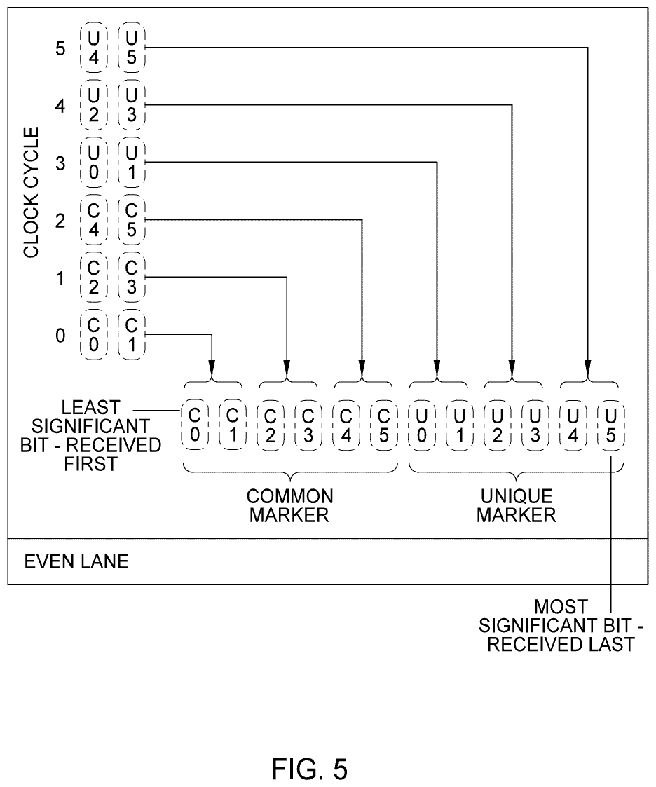

FIG. 5 illustrates the appearance of a common marker and a unique marker extracted from a data stream for an even lane, according to an example.

For the even lanes, the unique marker follows the common marker. The even lanes do not have a delay.

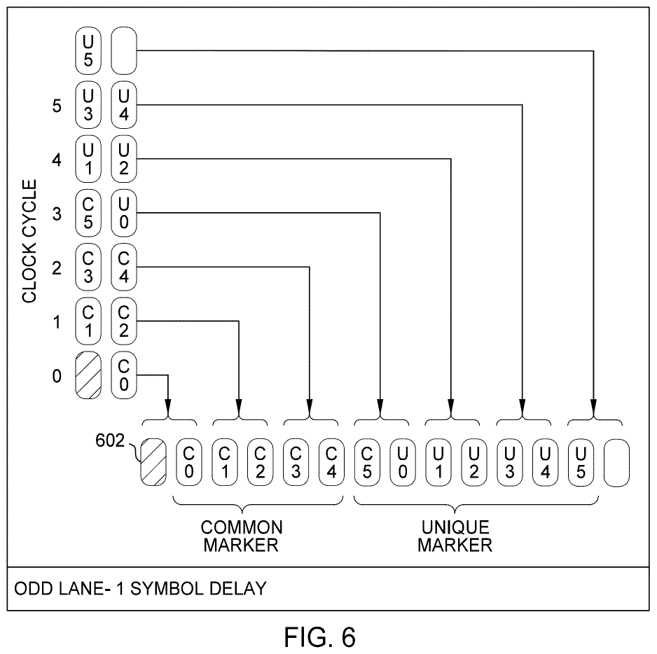

FIG. 6 illustrates the appearance of a common marker and a unique marker extracted from a data stream for an odd lane, according to an example.

For the odd lanes, the unique marker follows the common marker. The odd lanes have a delay 602. The delay 602 has a length of one symbol, that is, 10 bits.

Regarding FIGS. 5 and 6, C0 through C5 are the symbols of the common marker, which is common across all lanes. U0 through U5 are the symbols of the unique markers, which are unique to each lane. The common and unique markers may not each be 6 symbols (60 bits) in length. The 6 symbol length was chosen for illustration purposes only. Regardless of the length, the aliasing principle is the same. Likewise, 20 bits per lane are shown to be received per clock cycle. This is common for a 200 Gbps transceiver and also makes aliasing simpler to show. However, this can be higher or lower.

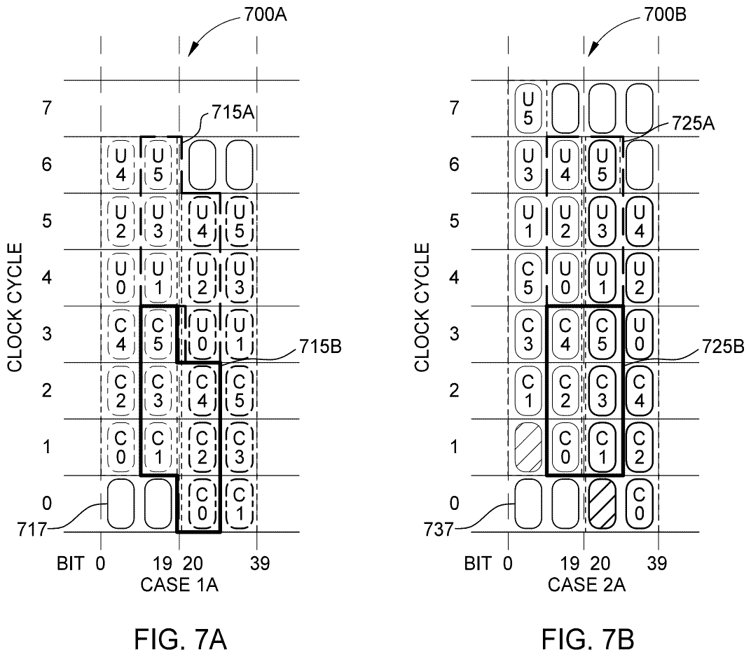

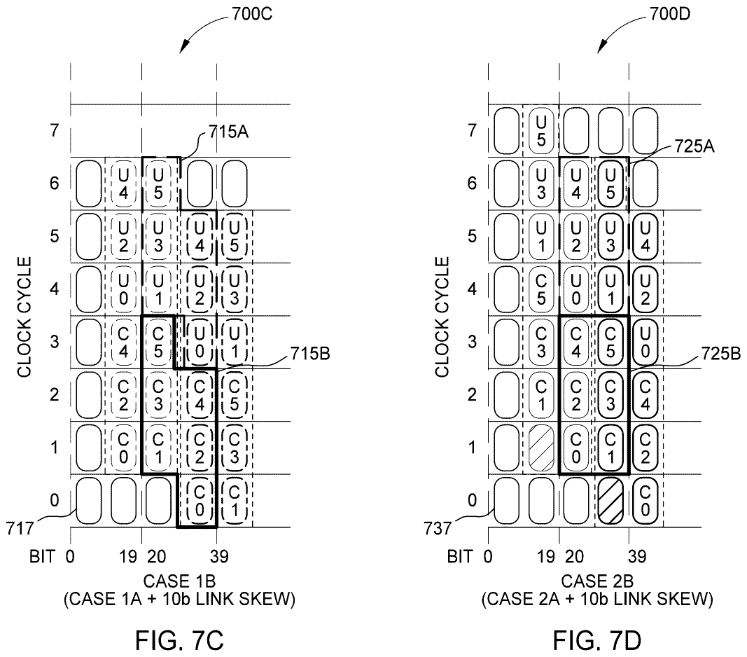

FIGS. 7A-7D illustrate the unique marker that may be extracted after the aliased common marker is detected to detect common marker aliasing in symbol-pair multiplexing, according to an example.

In a first example architecture, the unique marker is used for the anti-aliasing logic. A method including the use of correlators may be used to detect common markers on one or more lanes. After any common marker is detected, the subsequent unique marker is extracted and compared to known unique markers. If a unique marker match is obtained, it is guaranteed that the common marker detection was not an aliased marker, and the physical link can be correctly de-multiplexed. If a unique marker match is not obtained, the common marker detection was likely a result of aliasing.

In FIG. 7A, the diagram 700A depicts the outline of the unique marker 715A that is extracted after the aliased common marker was detected for two even numbered lanes that are spatially adjacent. The outline of the common marker 715B is shown directly below the outline of the unique marker 715A. The shift or delay 717 is shown below the lower lane (left side). The delay 717 may be one clock cycle.

Similarly for FIG. 7C, the diagram 700C depicts the outline of the unique marker 715A that is extracted after the aliased common marker was detected for two even numbered lanes that are spatially adjacent. The outline of the common marker 715B is shown directly below the outline of the unique marker 715A.

In FIG. 7B, the diagram 700B depicts the outline of the unique marker 725A that is extracted after the aliased common marker was detected for two odd numbered lanes that are spatially adjacent. The outline of the common marker 725B is shown directly below the outline of the unique marker 725A. The shift or delay 737 is shown below the lower lane (left side). The delay 737 may be one clock cycle.

Similarly for FIG. 7D, the diagram 700D depicts the outline of the unique marker 725A that is extracted after the aliased common marker was detected for two odd numbered lanes that are spatially adjacent. The outline of the common marker 725B is shown directly below the outline of the unique marker 725A.

In accordance with FIGS. 7A-7D, there is a mix of unique markers from the two adjacent lanes. As the unique markers are unique to each lane, the unique marker extracted from aliasing would not match any of the known unique markers. This additional check ensures that the correct physical link skew is determined, regardless of the presence of aliasing. The use of unique alignment markers to validate the correctness of the detection is different. Thus, in the first architecture, since the common alignment marker is not entirely accurate in determining the starting point, after detection of the common alignment marker, the unique alignment marker can be checked to confirm in determining whether the common alignment marker experiences aliasing or not. The benefits of using a unique marker for anti-aliasing includes maintaining the accuracy and integrity of the symbol pair multiplexing, thus reducing the likelihood of distortion and errors.

In a second example architecture, common marker detection status of adjacent lanes may be used to detect cases of aliasing.

Such anti-aliasing logic focuses on lane N and lane N+1 for N=0:7 and makes use of the delay between detections to identify aliasing. It should be appreciated that for N=7, N+7=0, according to the example. If the exact pattern of common marker detections were made as shown in Cases 1A and 1B and Cases 2A and 2B, the presence of aliasing can be inferred and cancelled out.

More specifically, for Case 1A aliasing, if lane N was detected as even on cycle M (310; FIG. 3A) and detected as odd on cycle M−1 (315; FIG. 3A), and lane N+1 was detected as even on cycle M−1 (312; FIG. 3A), it may be concluded that, with reference to Case 1A, the odd lane detection on lane N in cycle M−1 (315; FIG. 3A) was a result of aliasing.

Likewise, for Case 1B aliasing, if lane N was detected as even on cycle M (310; FIG. 3C), and lane N+1 was detected as odd and even on cycle M−1 (315, 312; FIG. 3C), it may be concluded that, with reference to Case 1B, the odd lane detection on lane N+1 in cycle M−1 (315, FIG. 3C) was a result of aliasing.

For Case 2A aliasing, if lane N was detected as even and odd on cycle M (325, 320; FIG. 3B), and lane N+1 was detected as odd on cycle M−1 (322; FIG. 3B), it can be concluded that, with reference to Case 2A, the even lane detection on lane N in cycle M (325; FIG. 3B) was a result of aliasing.

Likewise, for Case 2B aliasing, if lane N was detected as odd on cycle M (320; FIG. 3D), and lane N+1 was detected as even on cycle M (325; FIG. 3D), and lane N+1 was detected as odd on cycle M−1 (322; FIG. 3D), it can be concluded that, with reference to Case 2D, the even lane detection on lane N+1 in cycle M (325; FIG. 3D) was a result of aliasing.

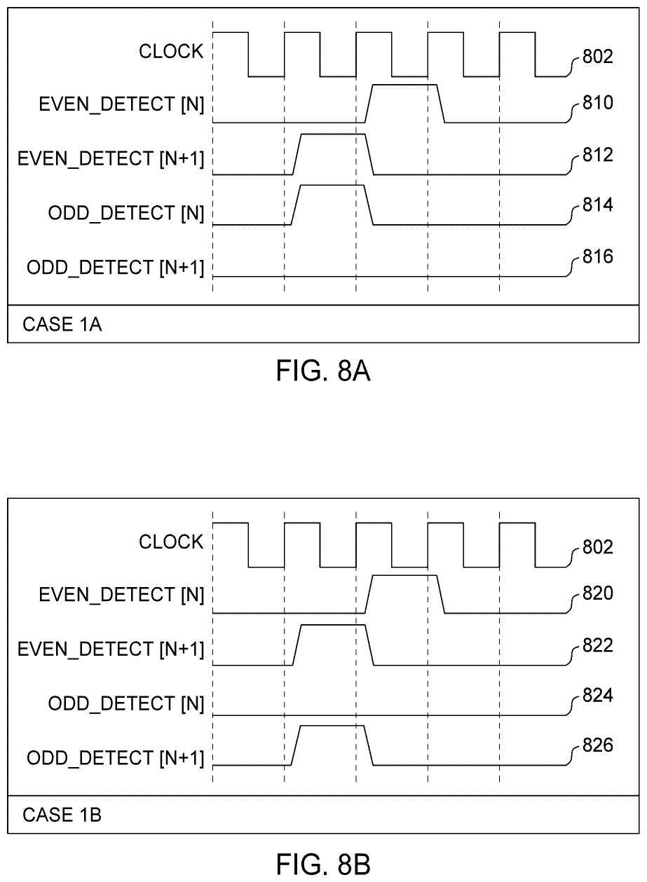

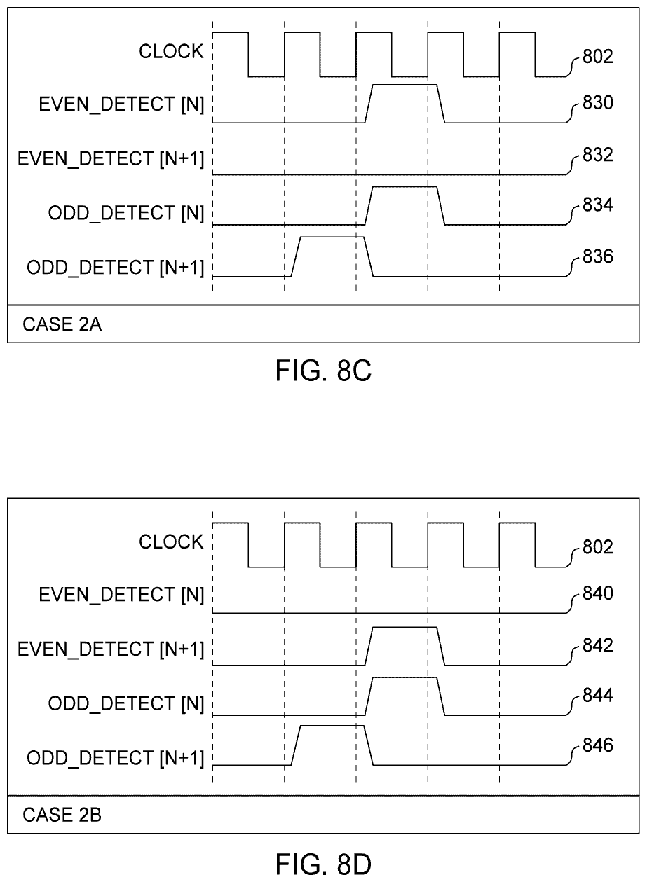

FIGS. 8A-8D illustrate timing diagrams for detecting the aliased common marker, according to an example.

In FIG. 8A, for Case 1A, a clock signal 802 is generated. In a first clock cycle (cycle 0), a first lane, that is, lane N is detected as an odd lane 814. Further, in the first clock cycle (cycle 0), the next lane, that is, lane N+1 is detected as an even lane 812. In the next clock cycle (cycle 1), the first lane N is detected as an even lane 810. From this, it is concluded that the odd lane detection on Lane N was a result of aliasing. The delay between detections is used to identify the aliasing.

In FIG. 8B, for Case 1B, a clock signal 802 is generated. In a first clock cycle (cycle 0), a second lane, that is, lane N+1 is detected as an even lane 822 and as an odd lane 826. In the next clock cycle (cycle 1), the first lane N is detected as an even lane 820. As such, it is concluded that the odd lane detection on Lane N+1 was a result of aliasing. The delay between detections is used to identify the aliasing.

In FIG. 8C, for Case 2A, a clock signal 802 is generated. In a first clock cycle (cycle 0), a second lane, that is, lane N+1 is detected as an odd lane 836. In the next clock cycle (cycle 1), the first lane N is detected as an even lane 830 and as an odd lane 834. From this, it is concluded that the even lane detection on Lane N was a result of aliasing. The delay between detections is used to identify the aliasing.

In FIG. 8D, for Case 2B, a clock signal 802 is generated. In a first clock cycle (cycle 0), a second lane, that is, lane N+1 is detected as an odd lane 846. In the next clock cycle (cycle 1), the first lane N is detected as an odd lane 844 and the second lane N+1 is detected as an even lane 842. From this, it is concluded that the even lane detection on Lane N+1 was a result of aliasing. The delay between detections is used to identify the aliasing.

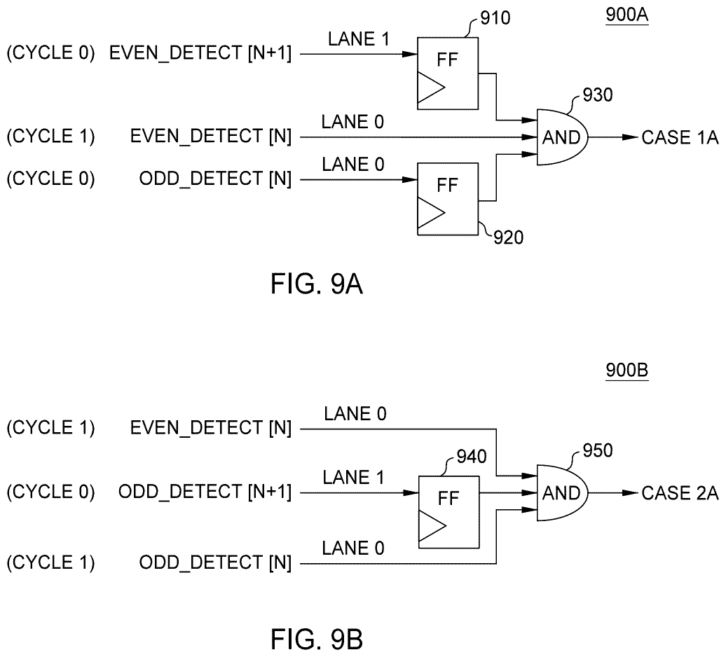

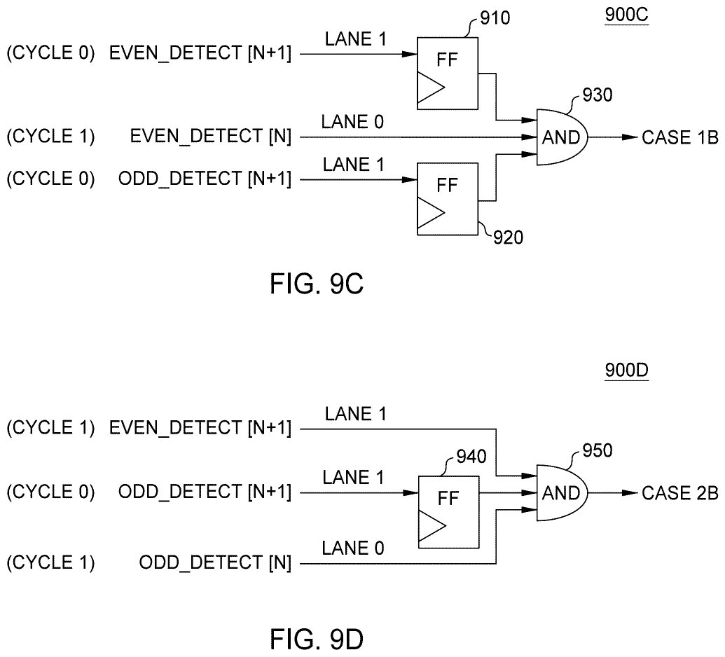

FIGS. 9A-9D illustrate circuits used to detect the aliased common marker, according to an example.

FIG. 9A illustrates a first circuit 900A for detecting common marker aliasing in Case 1A. The first circuit 900A includes a first flip-flop 910 and a second flip-flop 920 coupled to an AND gate 930. On a first clock cycle (cycle 0), lane N is detected as an odd lane. Lane N can be the 0 lane. Also, on the first clock cycle (cycle 0), lane N+1 is detected as an even lane. Lane N+1 can be the 1 lane. This is shown in FIG. 3A, where 315 is an odd lane detection and 312 is an even lane detection. In the next clock cycle (cycle 1), lane N is detected as an even lane. This is shown in FIG. 3A where 310 is an even lane detection. Thus, the basic logic misinterpreted the odd lane detection as being a valid common marker. This is referred to as the common marker aliasing issue. As such, the first circuit 900A identifies lane N as an even lane with aliasing. Thus, Case 1A=even_detect[N+1][1]×even_detect[N][0]×odd_detect[N][1].

signal[0] represents the value of the signal in the current clock cycle. signal[1] represents the value of signal in the previous clock cycle. The multiplication describes a logical AND operation.

FIG. 9B illustrates a second circuit 900B for detecting common marker aliasing in Case 2A. The second circuit 900B includes a single flip-flop 940 coupled to an AND gate 950. On a first clock cycle (cycle 0), lane N+1 is detected as an odd lane. Lane N+1 can be the 1 lane. This is shown in FIG. 3B, where 322 is an odd lane detection. In the next clock cycle (cycle 1), lane N is detected as an even lane and as an odd lane. Lane N can be the 0 lane. This is shown in FIG. 3B where 320 is an odd lane detection and 325 is an even lane detection. Thus, the basic logic misinterpreted the even lane detection as being a valid common marker. This is referred to as the common marker aliasing issue. As such, the second circuit 900B identifies lane N as an odd lane with aliasing. Thus, Case 2A=even_detect[N][0]×odd_detect[N+1][1]×odd_detect[N][0].

signal[0] represents the value of the signal in the current clock cycle. signal[1] represents the value of signal in the previous clock cycle. The multiplication describes a logical AND operation.

FIG. 9C illustrates a third circuit 900C for detecting common marker aliasing in Case 1B. The third circuit 900C includes a first flip-flop 910 and a second flip-flop 920 coupled to an AND gate 930. On a first clock cycle (cycle 0), lane N+1 is detected as an even lane and as an odd lane. Lane N+1 can be the 1 lane. This is shown in FIG. 3C where 312 is an even lane detection and 315 is an odd lane detection. In the next clock cycle (cycle 1), lane N is detected as an even lane. Lane N can be the 0 lane. This is shown in FIG. 3C where 310 is an even lane detection. Thus, the basic logic misinterpreted the odd lane detection as being a valid common marker. This is referred to as the common marker aliasing issue. As such, the third circuit 900C identifies lane N as an even lane with aliasing. Thus, Case 1B=even_detect[N+1][1]×even_detect[N][0]×odd_detect[N+1][1].

signal[0] represents the value of the signal in the current clock cycle. signal[1] represents the value of signal in the previous clock cycle. The multiplication describes a logical AND operation.

FIG. 9D illustrates a fourth circuit 900D for detecting common marker aliasing in Case 2B. The fourth circuit 900D includes a single flip-flop 940 and an AND gate 950. On a first clock cycle (cycle 0), lane N+1 is detected as an odd lane. Lane N+1 can be the 1 lane. This is shown in FIG. 3D where 322 is an odd detection. In the next clock cycle (cycle 1), lane N+1 is detected as an even lane and lane N is detected as an odd lane. Thus, the basic logic misinterpreted the even lane detection as being a valid common marker. This is referred to as the common marker aliasing issue. As such, the fourth circuit 900D identifies lane N as an odd lane with aliasing. Thus, Case 2B=even_detect[N+1][0]×odd_detect[N+1][1]×odd_detect[N][0].

signal[0] represents the value of the signal in the current clock cycle. signal[1] represents the value of signal in the previous clock cycle. The multiplication describes a logical AND operation.

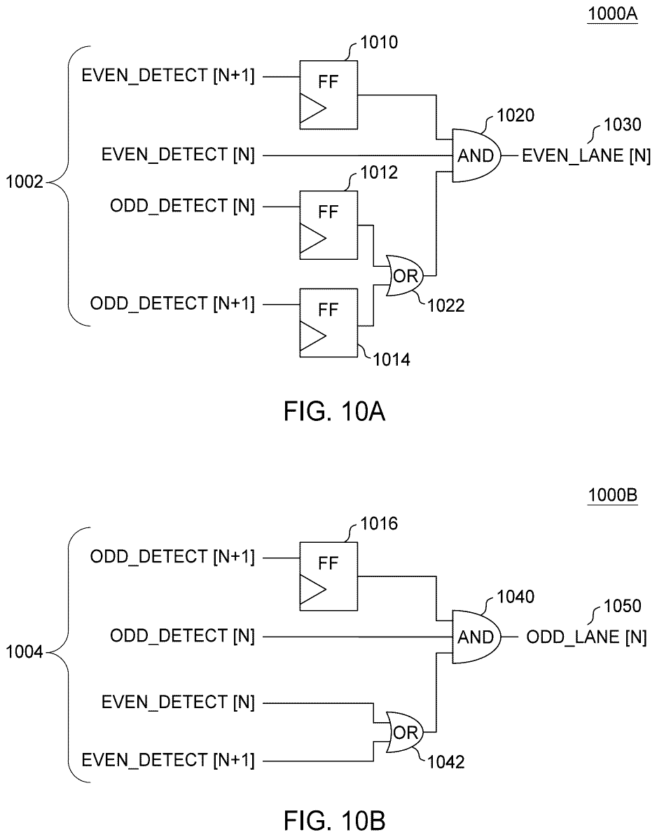

Given that Cases 1A and 1B result in lane N being identified as an even lane with aliasing, and Cases 2A and 2B result in lane N being identified as an odd lane with aliasing, the first circuit 900A, the second circuit 900B, the third circuit 900C, and the fourth circuit 900D can be combined and optimized to form a general circuit for the detection of aliased common alignment markers, as shown in FIGS. 10A-10B.

FIGS. 10A-10B illustrate circuits used to detect an even lane and an odd lane to avoid common marker aliasing, according to an example.

FIG. 10A illustrates a circuit 1000A for an even lane with aliasing. The circuit 1000A includes three flip flops, that is, a first flip flop 1010, a second flip flop 1012, and a third flip flop 1014. The first flip flop 1010, the second flip flop 1012, and the third flip flop 1014, as well as the AND gate 1020, receive a plurality of inputs 1002. The output of the first flip flop 1010 is fed directly into an AND gate 1020. The outputs of the second flip flop 1012 and the third flip flop 1014 are fed directly into an OR gate 1022. The output of the OR gate 1022 is fed into the AND gate 1020. The output of the AND gate 1020 is an even lane with aliasing. In other words, a selected lane has been identified as an even lane with aliasing.

FIG. 10B illustrates a circuit 1000B for an odd lane with aliasing. The circuit 1000B includes a single flip flop 1016. The flip flop 1016, as well as the AND gate 1040 and the OR gate 1042 receive a plurality of inputs 1004. The output of the flip flop 1016 is fed directly into an AND gate 1040. The output of the OR gate 1042 is fed into the AND gate 1040. The output of the AND gate 1040 is an odd lane with aliasing. In other words, a selected lane has been identified as an odd lane with aliasing.

The output even_lane[N] 1030 indicates that common alignment marker aliasing was detected on lane N and lane N was even numbered.

The output odd_lane[N] 1050 indicates that common alignment marker aliasing was detected on lane N and lane N was odd numbered.

The equations can be given as follows:

$$even\_lane [ N ] = Case 1 A + Case 1 B$$

$$even\_lane [ N ] = ( even\_detect [ N + 1 ] [ 1 ] \times even\_detect [ N ] [ 0 ] \times odd\_detect [ N ] [ 1 ] ) + ( even\_detect [ N + 1 ] [ 1 ] \times even\_detect [ N ] [ 0 ] \times odd\_detect [ N + 1 ] [ 1 ] )$$

$$even\_lane [ N ] = even\_detect [ N + 1 ] [ 1 ] \times even\_detect [ N ] [ 0 ] \times ( odd\_detect [ N ] [ 1 ] + odd\_detect [ N + 1 ] [ 1 ] )$$

$$odd\_lane [ N ] = Case 2 A + Case 2 B$$

$$odd\_lane [ N ] = ( even\_detect [ N ] [ 0 ] \times odd\_detect [ N + 1 ] [ 1 ] \times odd\_detect [ N ] [ 0 ] ) + ( even\_detect [ N + 1 ] [ 0 ] \times odd\_detect [ N + 1 ] [ 1 ] \times odd\_detect [ N ] [ 0 ] )$$

$$odd\_lane [ N ] = odd\_detect [ N + 1 ] [ 1 ] \times odd\_detect [ N ] [ 0 ] \times ( even\_detect [ N ] [ 0 ] + even\_detect [ N + 1 ] [ 0 ] )$$

As such, the use of common alignment marker detections from an adjacent lane to detect and cancel out common marker aliasing is a unique feature of the example embodiments.

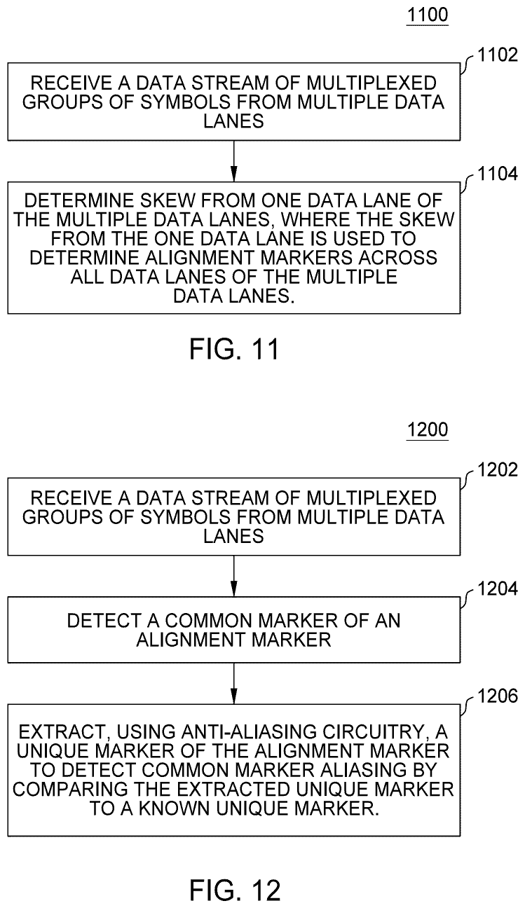

FIG. 11 illustrates a flowchart 1100 for alignment marker detection by determining skew from one lane of the multiple data lanes to determine skew across all data lanes, according to an example.

At 1102, a data stream of multiplexed groups of symbols from multiple data lanes is received. For example, referring to FIG. 2, the output 205 is received at the correlator circuit 210. In one example, the groups of symbols include symbol-pairs. In another example, the groups of symbols include symbol-quartets.

At 1104, the skew from one data lane is determined where the skew from the one data lane is used to determine alignment markers across all data lanes of the multiple data lanes.

FIG. 12 illustrates a flowchart 1200 for alignment marker detection by using anti-aliasing circuitry to extract a unique marker to detect common marker aliasing, according to an example.

At 1202, a data stream of multiplexed groups of symbols from multiple data lanes is received. For example, referring to FIG. 2, the output 205 is received at the correlator circuit 210. In one example, the groups of symbols include symbol-pairs. In another example, the groups of symbols include symbol-quartets.

At 1204, a common marker of an alignment marker is detected. The common marker is common across all lanes and is used to align the incoming deserialized data to symbol and codeword boundaries.

At 1206, a unique marker is extracted, using anti-aliasing circuitry, to detect common marker aliasing. The common marker aliasing is detected by comparing the extracted unique marker to a known unique marker.

In conclusion, the example embodiments propose solutions to address issues in detecting alignment markers in wired communication systems using symbol multiplexing and to address issues in misidentification of lane alignment markers in wired communication systems using symbol-pair multiplexing. For the first issue, in a physical link, it is sufficient to only check for alignment markers on one lane to determine the physical link skew using a set of correlator circuits. Thus, the use of one lane to detect skew on the physical link is a novel aspect in determining the alignment markers in all lanes. For the second issue, area-optimal architectures are employed to prevent misidentification of lane alignment markers due to common marker aliasing. In a first architecture, the unique marker is used for the anti-aliasing logic. In a second architecture, the common marker detection status of adjacent lanes is used to detect cases of aliasing. In other words, unique alignment markers may be used to validate the correctness of the detection or common alignment marker detections from adjacent lanes may be used to detect and cancel out common marker aliasing.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. Alignment detection circuitry comprising:
a buffer configured to output a data stream of multiplexed groups of symbols from multiple data lanes; and
a set of correlators configured to determine physical link skew from one data lane of the multiple data lanes, wherein the physical link skew from the one data lane equals the physical link skew from each of the multiple data lanes transmitted over a same physical link.

2. The alignment detection circuitry of claim 1, wherein a maximum value of the physical link skew is based on a symbol multiplexing method.

3. The alignment detection circuitry of claim 2, wherein, in a sequential detection method, the set of correlators is initially configured to search for alignment markers by assuming that the one data lane of the multiple data lanes is either even or odd numbered.

4. The alignment detection circuitry of claim 3, wherein the search is performed during a first time window equal to a spacing between the alignment markers.

5. The alignment detection circuitry of claim 4, wherein, once the first time window ends, the set of correlators is configured to search for the alignment markers by assuming that the one data lane of the multiple data lanes is either even or odd numbered.

6. The alignment detection circuitry of claim 5, wherein the search is performed during a second time window.

7. The alignment detection circuitry of claim 6, wherein, if a common marker of the alignment markers is detected during the first time window, the one data lane of the multiple data lanes is designated as either even or odd numbered and wherein anti-aliasing circuitry performs common marker aliasing detection.

8. The alignment detection circuitry of claim 2, wherein, in a concurrent detection method, the set of correlators is configured to search for alignment markers in a single alignment marker window such that a first subset of the set of correlators assumes an even lane and a second subset of the set of correlators assumes an odd lane.

9. Alignment detection circuitry comprising:
a buffer configured to output a data stream of multiplexed groups of symbols from multiple data lanes;
a set of correlators configured to detect a common marker of an alignment marker; and
anti-aliasing circuitry configured to extract a unique marker of the alignment marker to detect common marker aliasing by comparing the extracted unique marker to a known unique marker.

10. The alignment detection circuitry of claim 9, wherein, if a match is obtained between the extracted unique marker and the known unique marker, then it is determined that the common marker is not an aliased marker.

11. The alignment detection circuitry of claim 9, wherein, if a match is not obtained between the extracted unique marker and the known unique marker, then it is determined that the common marker is likely an aliased marker.

12. Alignment detection circuitry comprising:
a buffer configured to output a data stream of multiplexed groups of symbols from multiple data lanes; and
anti-aliasing circuitry configured to use common marker detection status of adjacent data lanes of the multiple data lanes to detect common marker aliasing.

13. The alignment detection circuitry of claim 12, wherein the common marker aliasing is determined by a detection delay between the adjacent data lanes.

14. The alignment detection circuitry of claim 12, wherein the common marker aliasing is cancelled out upon detection.

15. The alignment detection circuitry of claim 12, wherein, if on a first clock cycle, a first data lane is detected as an odd lane and a second data lane is detected as an even lane, and if on a next clock cycle the first data lane is detected as an even lane, then it is determined that the odd lane detection has occurred as a result of common marker aliasing and that the first data lane is an even lane.

16. The alignment detection circuitry of claim 12, wherein, if on a first clock cycle, a second data lane is detected as an even lane and as an odd lane, and if on a next clock cycle a first data lane is detected as an even lane, then it is determined that the odd lane detection has occurred as a result of common marker aliasing and that the first data lane is an even lane.

17. The alignment detection circuitry of claim 12, wherein, if on a first clock cycle, a second data lane is detected as an odd lane, and if on a next clock cycle a first data lane is detected as an even lane and an odd lane, then it is determined that the even lane detection has occurred as a result of common marker aliasing and that the first data lane is an odd lane.

18. The alignment detection circuitry of claim 12, wherein, if on a first clock cycle, a second data lane is detected as an odd lane, and if on a next clock cycle a first data lane is detected as an odd lane and the second data lane is detected as an even lane, then it is determined that the even lane detection has occurred as a result of common marker aliasing and that the first data lane is an odd lane.

19. The alignment detection circuitry of claim 12, wherein, for even lane detection, the anti-aliasing circuitry includes a first flip flop coupled to a first logic gate, and second and third flip flops coupled to a second logic gate, the second logic gate further coupled to the first logic gate.

20. The alignment detection circuitry of claim 12, wherein, for odd lane detection, the anti-aliasing circuitry includes a first flip flop coupled to a first logic gate, and a second logic gate further coupled to the first logic gate.
